(19) United States
(12) Patent Application Publication
(10) Pub. No.: US 2022/0304067 A1
(43) Pub. Date: Sep. 22, 2022

(54) METHOD AND APPARATUS FOR UE REPORTING FOR SON-BASED OPTIMIZATION IN MR-DC

(71) Applicant: Samsung Electronics Co., Ltd., Suwon-si (KR)

(72) Inventors: Nishithkumar D. Tripathi, Parker, TX (US); Kyeongin Jeong, Allen, TX (US)

(21) Appl. No.: 17/696,637

(22) Filed: Mar. 16, 2022

Related U.S. Application Data
(60) Provisional application No. 63/162,902, filed on Mar. 18, 2021.
(60) Provisional application No. 63/193,397, filed on May 26, 2021.

(51) Int. Cl. H04W 74/08; H04W 24/08

(52) U.S. Cl. CPC H04W 74/0833; H04W 24/08

(57) ABSTRACT

Methods and apparatuses for an enhanced UE reporting operation in a wireless communication system. A method of the UE comprises: performing a random access (RA) procedure in a cell of a master cell group (MCG) or a secondary cell group (SCG); generating and storing RA information for the RA procedure and information indicating whether the RA information is used for a primary cell (PCell) or a primary secondary cell (PSCell); generating a radio resource control (RRC) message including the RA information and the information indicating whether the RA information is used for the PCell or the PSCell; and transmitting, to a master node base station (MN-BS), the RRC message using a signaling radio bearer 1 (SRB1).

### CROSS-REFERENCE TO RELATED APPLICATIONS AND CLAIM OF PRIORITY

The present application claims priority to U.S. Provisional Patent Application No. 63/162,902, filed on Mar. 18, 2021, and U.S. Provisional Patent Application No. 63/193,397, filed on May 26, 2021. The content of the above-identified patent document is incorporated herein by reference.

### TECHNICAL FIELD

The present disclosure relates generally to wireless communication systems and, more specifically, the present disclosure relates to an enhanced user equipment (UE) reporting for self-organizing network (SON)-based optimization for MR-DC a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an enhanced UE reporting for SON-based optimization for MR-DC a wireless communication system.

In one embodiment, a UE in a wireless communication system is provided. The UE comprises: a transceiver configured to perform a random access (RA) procedure in a cell of a master cell group (MCG) or a secondary cell group (SCG); and a processor operably coupled to the transceiver, the processor configured to: generate, and store RA information for the RA procedure and information indicating whether the RA information is used for a primary cell (PCell) or a primary secondary cell (PSCell), and generate a radio resource control (RRC) message including the RA information and the information indicating whether the RA information is used for the PCell or the PSCell, wherein the transceiver is further configured to transmit, to a master node base station (MN-BS), the RRC message using a signaling radio bearer 1 (SRB1).

In another embodiment, a master node base station (MN-BS) in a wireless communication system is provided. The MN-BS comprises: a transceiver configured to receive, from a UE, an RRC message using an SRB1; and a processor operably coupled with the transceiver, the processor configured to: identify, from the RRC message, RA information for a RA procedure and information, wherein the RA procedures is performed in a cell of a master cell group, and identify the information to determine whether the RA information is used for a PCell or a PSCell, wherein the transceiver is further configured to forward the RRC message to a secondary node base station (SN-BS) when the RA information is used for the PSCell.

In yet another embodiment, a method of a UE in a wireless communication system is provided. The method comprises: performing an RA procedure in a cell of an MCG or a SCG; generating and storing RA information for the RA procedure and information indicating whether the RA information is used for a PCell or a PSCell; generating an RRC message including the RA information and the information indicating whether the RA information is used for the PCell or the PSCell; and transmitting, to an MN-BS, the RRC message using an SRB1.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of mechanism of enhanced UE reporting according to embodiments of the present disclosure;

FIG. 7 illustrates an example of UE-network and intra-network signaling procedures for UE reporting to support SON optimization in MR-DC according to embodiments of the present disclosure;

FIG. 8A illustrates an example of UE procedure for enhanced RA reporting to support SON optimization in MR-DC according to embodiments of the present disclosure;

FIG. 8B illustrates an example of UE procedure for enhanced RA reporting to support SON optimization in MR-DC according to embodiments of the present disclosure;

FIG. 9A illustrates an example of MN procedure for enhanced RA reporting to support SON optimization in MR-DC according to embodiments of the present disclosure;

FIG. 9B illustrates an example of MN procedure for enhanced RA reporting to support SON optimization in MR-DC according to embodiments of the present disclosure; and

FIG. 10 illustrates an example of SN procedure for enhanced RA reporting to support SON optimization in MR-DC according to embodiments of the present disclosure; and

FIG. 11 illustrates a flowchart of method for enhanced UE reporting according to embodiments of the present disclosure.

### DETAILED DESCRIPTION

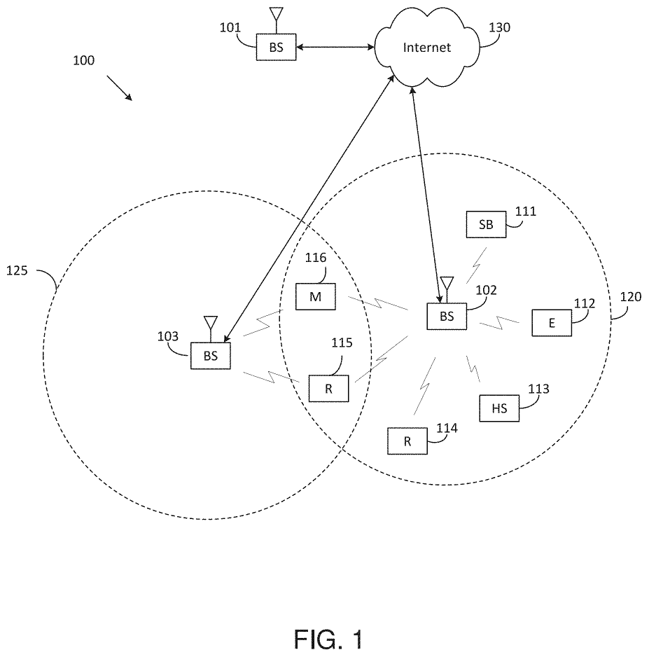

FIG. 1 through FIG. 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.4.0, “NR; Physical channels and modulation”; 3GPP TS 38.212 v16.4.0, “NR; Multiplexing and Channel coding”; 3GPP TS 38.213 v16.4.0, “NR; Physical Layer Procedures for Control”; 3GPP TS 38.214 v16.4.0, “NR; Physical Layer Procedures for Data”; 3GPP TS 38.321 v16.3.0, “NR; Medium Access Control (MAC) protocol specification”; and 3GPP TS 38.331 v16.3.1, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an enhanced UE reporting for SON-based optimization for MR-DC a wireless communication system. In certain embodiments, and one or more of the gNBs 101-103 includes circuitry, programing, or a combination thereof, for an enhanced UE reporting for SON-based optimization for MR-DC a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

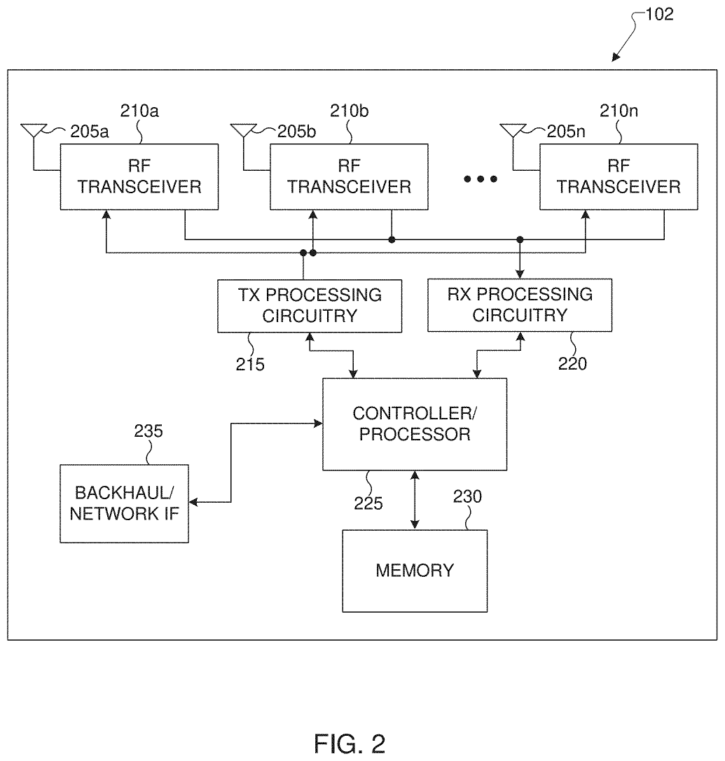

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support an enhanced UE reporting for an enhanced UE reporting for SON-based optimization for MR-DC a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

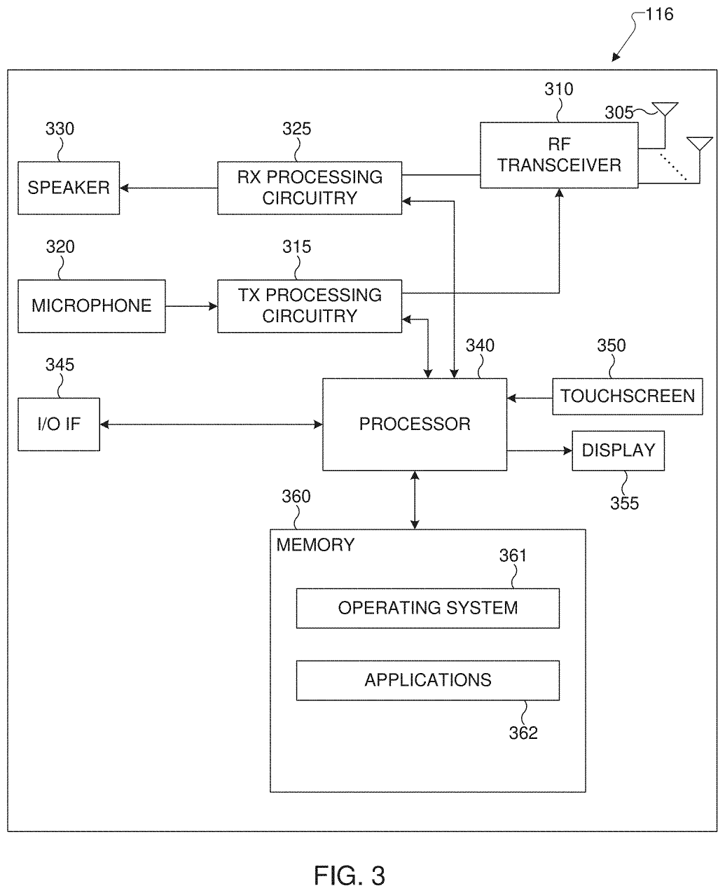

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for an enhanced UE reporting for SON-based optimization for MR-DC a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

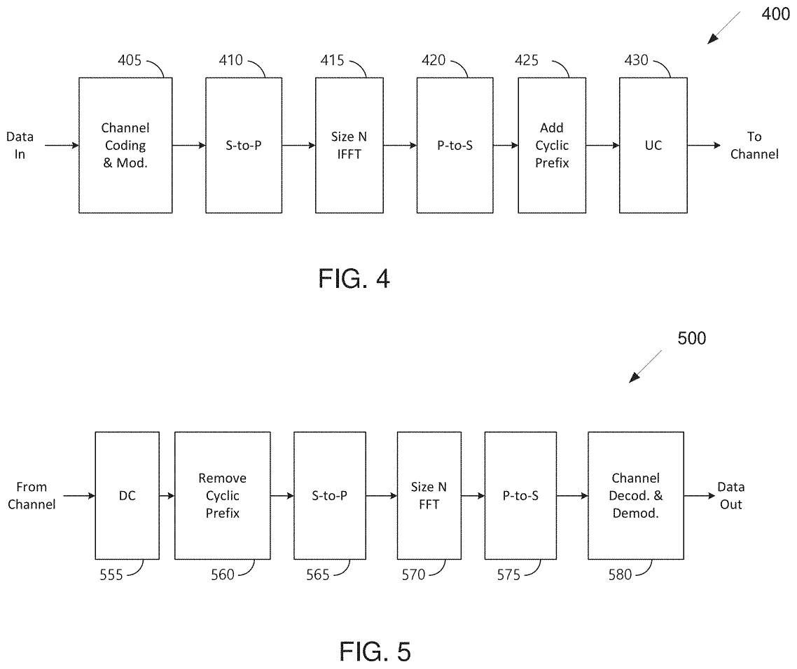

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

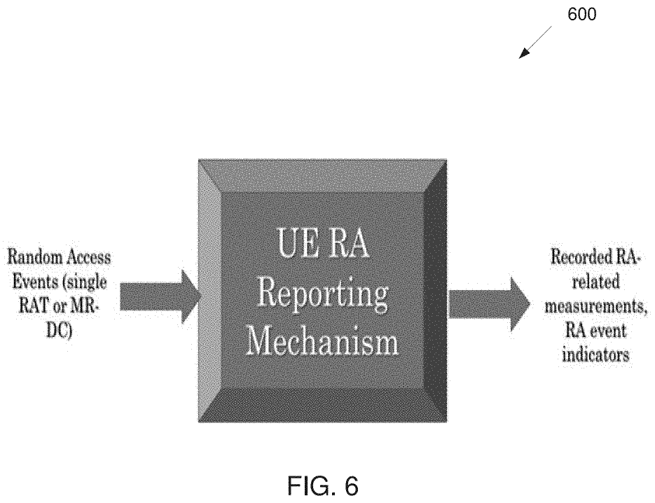

FIG. 6 illustrate an example of mechanism of enhanced UE reporting 600 according to embodiments of the present disclosure. An embodiment of the mechanism of enhanced UE reporting 600 shown in FIG. 6 is for illustration only.

FIG. 6 illustrates an overall mechanism of UE reporting in support of random access (RA) optimization in multi radio-dual connection (MR-DC) scenarios by a self-organization network (SON) entity.

AS illustrated in FIG. 6, the UE observes events related to random access (e.g., number of preambles transmitted and any indications of power limits encountered) and records suitable measurements and indicators related to random access for the regular cell (primary cell (PCell)) of a master node (MN) as well as primary secondary cell (PSCell) of a secondary node (SN). Upon request by the MN or the SN, the UE provides RA reports to the eNB/gNB.

In particular, the UE provides the RA information and other reports such as radio link failure (RLF) reports and connection establishment failure (CEF) reports for SCells (e.g., PSCells) of SNs to the network in support of MR-DC optimization. A SON entity obtains the UE reports as well as any additional eNB/gNB reports to optimize RA parameters (and other network parameters). Such optimized RA (and other non-RA) parameters are conveyed to the relevant eNBs/gNBs by the SON entity.

Examples of MR-DC flavors include E-UTRA-NR dual connectivity (EN-DC), NR-E-UTRA dual connectivity (NE-DC), and NR-NR dual connectivity (NR-DC). In case of EN-DC, E-UTRA/LTE eNB is the MN and NR gNB is the SN. In case of NE-DC, NR gNB is the MN and E-UTRA/LTE eNB is the SN. In case of NRE-DC, NR gNB is the MN and NR gNB is the SN.

In one embodiment of the present disclosure, a signaling exchange takes place between (i) the MN and the SN, (ii) the MN and the UE, and/or (iii) the SN and the UE to enable the UE to convey RA, RLF, and CEF reports associated with cells of SNs (e.g., PSCells) to the network in MR-DC scenarios.

In one example approach, an indicator about the availability of the reports about the SN cells is sent from the UE to the MN via signaling radio bearer 1 (SRB1). The MN itself retrieves the report from the UE in an example implementation. In another example implementation, the MN informs the current or new SN about the availability of UE reports via XnAP signaling. In such case, the SN retrieves the UE reports via the MN using SRB1 between the UE and the MN and the Xn connection between the MN and the SN or the SN retrieves the UE reports directly using SRB3 between itself and the UE.

In another approach, an indicator about the availability of the reports about the SN cells is sent from the UE to the SN directly via SRB3. The SN retrieves the UE reports via the MN using SRB1 between the UE and the MN and the Xn connection between the MN and the SN or the SN retrieves the UE reports directly using SRB3 between itself and the UE.

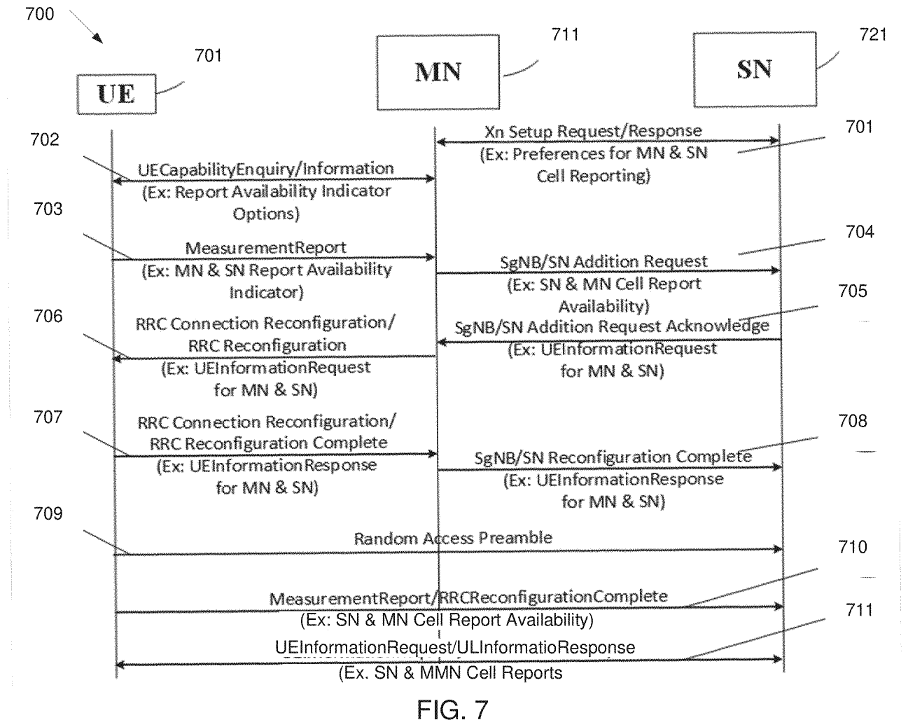

FIG. 7 illustrate an example of UE-network and intra-network signaling procedures 700 for UE reporting to support SON optimization in MR-DC according to embodiments of the present disclosure. The UE-network and intra-network signaling procedures 700 as may be performed by a UE (e.g., 111-116 as illustrated in FIG. 1) and a BS (e.g., 101-103 as illustrated in FIG. 1). An embodiment of the UE-network and intra-network signaling procedures 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

FIG. 7 shows the overall UE-network signaling procedure and the intra-network signaling procedure to illustrate example embodiments of the present disclosure to enable the UE to convey SN-related RA, RLF, and CEF reports to the eNB/gNB.

As illustrated in FIG. 7, in Step 701, in an embodiment of the present disclosure, the MN and the SN exchange the preferences or support for obtaining an indicator from the UE about the availability of report(s) of the MN cells and SN cells using XnAP messages such as Xn setup request and Xn setup response. In an example approach, an NG-RAN node, as an MN, may indicate support for a UE indicating the availability of RA, RLF, and CEF reports for an SN cell (e.g., PSCell) using SRB1 between the MN cell and the UE. Furthermore, in an example approach, an NG-RAN node, as an MN, may indicate support for the retrieval of a UE report about SN cell(s) using SRB1 between the MN cell and the UE and forwarding of such retrieved report(s) to an SN when MR-DC is newly established or has been in existence for some time with a UE.

In Step 701, in an embodiment of the present disclosure, an NG-RAN node, as an SN, may indicate support for a UE indicating the availability of RA, RLF, and CEF reports for an SN cell (e.g., PSCell) using SRB1 between the MN cell and the UE of the MN. Furthermore, in an example approach, an NG-RAN node, as an SN, may indicate support for receiving of MN-retrieved UE report(s) about SN cell(s) from the MN via the Xn interface.

In Step 701, in an embodiment of the present disclosure, an NG-RAN node, as an SN, may indicate support for a UE indicating the availability of RA, RLF, and CEF reports for an SN cell (e.g., PSCell) using SRB3 between the UE and an SN cell. Furthermore, in an example approach, an NG-RAN node, as an SN, may indicate support for receiving of UE report(s) about SN cell(s) using SRB3 between the UE and an SN cell.

In Step 701, in an embodiment of the present disclosure, an NG-RAN node, as an SN, may indicate support for a UE indicating the availability of RA, RLF, and CEF reports for an MN cell using SRB3 between the UE and an SN cell. Furthermore, in an example approach, an NG-RAN node, as an SN, may indicate support for receiving of UE report(s) about MN cell(s) using SRB3 between the UE and an SN cell.

In one embodiment of the present disclosure, the eNB/gNB support of (i) one or more modes of the UE's indications about the report availability for MN cell(s) and SN cell(s) and (ii) one or more modes of report retrievals is predefined in specifications (an “implicit” approach) to avoid the need for an explicit signaling exchange about such support in XnAP messages.

In Step 702, in an embodiment of the present disclosure, the MN sends a UECapabilityEnquiry message indicating the supported MN cell and SN cell reporting modes. In an embodiment of the present disclosure, the UE sends a UECapabilityInformation message indicating the supported MN cell and SN cell reporting modes.

In one embodiment of the present disclosure, the UE's support of (i) one or more modes of the UE's indications about the report availability for MN cell(s) and SN cell(s) and (ii) one or more modes of report retrievals by the MN and/or the SN is predefined in specifications (an “implicit” approach) to avoid the need for an explicit signaling exchange about such support in RRC messages.

In Step 703, in an embodiment of the present disclosure, the UE sends a MeasurementReport message indicating the availability of the RA, CEF, and RLF reports for MN cell(s) and SN cell(s). In an example approach, an IE such as “UE-MeasurementsAvailable-r16” is reused in the MeasurementReport message. In another approach, an IE equivalent to “UE-MeasurementsAvailable-r16” is used in the MeasurementReport message.

In Step 704, in an embodiment of the present disclosure, the MN conveys the availability of the RA, CEF, and RLF reports for MN cell(s) and/or SN cell(s) to the SN using an XnAP message such as SgNB addition request or SN addition request. As of release 16, the SgNB addition request message is used in case of EN-DC and SN addition request is used for other MR-DC scenarios such as NE-DC and NR-DC.

In Step 705, in an embodiment of the present disclosure, the SN conveys the RRC message “UEInformationRequest” in the XnAP SgNB addition request acknowledge or the SN addition request acknowledge to retrieve the RA, CEF, and/or RLF reports for MN cell(s) and/or SN cell(s) from the UE.

In Step 706, in an embodiment of the present disclosure, the MN sends an RRC message “RRC connection reconfiguration” (if the MN is an eNB) or “RRC reconfiguration” (if the MN is a gNB) and conveys the embedded RRC message “UEInformationRequest” received from the SN in the XnAP SgNB addition request acknowledge or the SN addition request acknowledge. In another approach, the MN sends an enhanced UEInformationRequest message to retrieve reports for MN cells and/or SN cells.

In yet another approach, the MN separately specifies MN cell report retrieval and SN cell report retrieval. For example, the MN cell report retrieval may be specified for SRB1 or SRB3. Similarly, the SN cell report retrieval may be specified for SRB1 or SRB3. Such distinction between MN cell report retrieval and SN cell report retrieval can be made in RRC messages such as the RRC connection reconfiguration message, RRC reconfiguration message or UEInformationRequest message. In an example approach, new IEs are added in existing RRC messages to facilitate retrieval of UE reports for SN cells and MN cells. The “UEInformationRequest” message includes the request for CEF, RA, and RLF reports as the IEs connEstFailReportReq-r16, ra-ReportReq-r16, and rlf-ReportReq-r16, respectively in Release 16. Such IEs or equivalent IEs can be used in R17 and beyond.

In Step 707, in an embodiment of the present disclosure, the UE responds with an RRC message “RRC connection reconfiguration complete” (if the MN is an eNB) or “RRC reconfiguration complete” (if the MN is a gNB) and conveys the embedded RRC message “UEInformationResponse.” The message UEInformationResponse contains the UE reports in the IEs such as connEstFailReport, ra-ReportList, and rlf-Report in R16. Such IEs or equivalent IEs can be used in R17 and beyond.

In Step 708, in an embodiment of the present disclosure, the MN provides the reports of SN cells and/or MN cells received from the UE to the SN using XnAP messages such as SgNB reconfiguration complete or SN reconfiguration complete. These XnAP messages include the UEInformationResponse carrying CEF, RA, and/or RLF reports.

In Step 709, the UE sends a RA preamble to an SN cell of the SN as part of the MR-DC establishment with the new SgNB or SN.

In Step 710, when a UE has SRB3 with the SgNB/SN, the UE informs the SgNB/AN about the availability of the RA, CEF, and/or RLF reports for SN cell(s) and/or MN cell(s) via an RRC message such as measurement report and RRCReconfigurationComplete. In an example approach, the UN indicates the report availability by using the existing or enhanced IE “UE-Measurements-Available-r16” in an RRC message.

In Step 711, the SN and the UE exchange UEInformationRequest and UEInformationResponse messages so that the SN can retrieve target RA, CEF, and RLF reports from the UE for MN cell(s) and/or SN cell(s).

In an embodiment of the present disclosure, in the “UEInformationResponse” message containing the UE's RA, CEF, and/or RLF reports in FIG. 7 discussions above, the UE explicitly identifies the information to belong to an MN cell such as PCell or an SN cell such as PSCell. In another approach, PCell is assumed to be default and SCell/PSCell is identified explicitly where needed (i.e., when a report is associated with SCell/PSCell). Furthermore, in the context of the RA report, the MN cell and SN cell is identified at the granularity of the RA procedure; the granularity at the RA attempt level is not needed.

While FIG. 7 illustrates the indications and retrieval of UE reports in the context of an SgNB/SN addition, an indication from the UE about the availability of the reports about SN cells (and MN cells) and retrieval of UE's reports are also supported in other MR-DC scenarios including SN modification, SN change, in other embodiments of the present disclosure. In such other embodiments of the present disclosure, the UE utilizes RRC messages identified in FIG. 7 above to provide report availability indications and reports to the MN and/or the SN. Furthermore, where applicable, the MN forwards the received UE report(s) to the SN and vice versa.

In an embodiment of the present disclosure, the XnAP “RRC transfer” message is used by the MN and/or the SN to convey the availability of the reports about SN cells and/or MN cells. In another embodiment, the XnAP “RRC transfer” message is used by the MN and/or the SN to convey the report requests (e.g., UEInformationRequest) and the UE reports retrieved from the UE (e.g., UEInformationResponse).

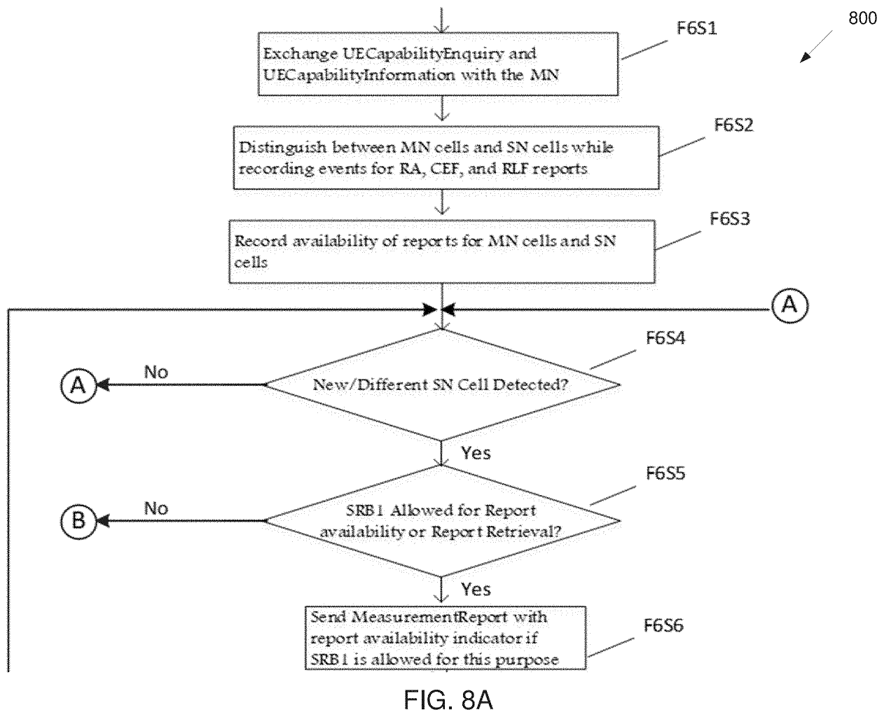

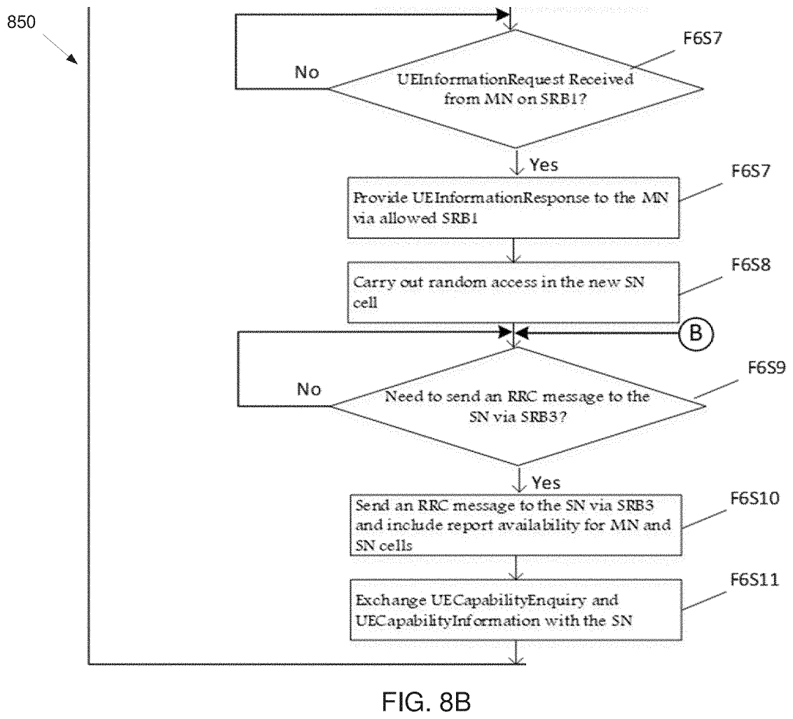

FIG. 8A illustrates an example of UE procedure 800 for enhanced RA reporting to support SON optimization in MR-DC according to embodiments of the present disclosure. The UE procedure 800 as may be performed by a UE (e.g., 111-116 as illustrated in FIG. 1). An embodiment of the UE procedure 800 shown in FIG. 8A is for illustration only. One or more of the components illustrated in FIG. 8A can be implemented in specialized circuitry configured to perform the noted functions or one or more of the components can be implemented by one or more processors executing instructions to perform the noted functions.

FIG. 8B illustrates an example of UE procedure 850 for enhanced RA reporting to support SON optimization in MR-DC according to embodiments of the present disclosure. The UE procedure 850 as may be performed by a UE (e.g., 111-116 as illustrated in FIG. 1). An embodiment of the UE procedure 850 shown in FIG. 8B is for illustration only. One or more of the components illustrated in FIG. 8B can be implemented in specialized circuitry configured to perform the noted functions or one or more of the components can be implemented by one or more processors executing instructions to perform the noted functions.

FIGS. 8A and 8B show the overall UE procedure to illustrate example embodiments of the present disclosure to enable the UE to convey enhanced RA, CEF, and RLF reports to the eNB/gNB in support of MR-DC scenarios.

As illustrated in FIGS. 8A and 8B, in Step F6S1, in an embodiment of the present disclosure, the MN sends a UECapabilityEnquiry message indicating the supported MN cell and SN cell reporting modes. In an embodiment of the present disclosure, the UE sends a UECapabilityInformation message indicating the supported MN cell and SN cell reporting modes.

In an embodiment of the present disclosure, the UE's support of (i) one or more modes of the UE's indications about the report availability for MN cell(s) and SN cell(s) and (ii) one or more modes of report retrievals by the MN and/or the SN is predefined in specifications (an “implicit” approach) to avoid the need for an explicit signaling exchange about such support in RRC messages.

In Step F6S2, in an embodiment of the present disclosure, the UE differentiates between an MN cell (e.g., PCell) and an SN cell (e.g., PSCell) in the reports such as RA report, RLP report, and RLF report. In an example approach, the UE indicates in the RA report if the RA information is for an MN cell such as PCell. In another approach, the UE indicates in the RA report if the RA information is for an SN cell such as PSCell.

In another approach, PCell is assumed to be default and SCell/PSCell is identified explicitly where needed (i.e., when a report is associated with SCell/PSCell). Furthermore, in the context of the RA report, the MN cell and/or the SN cell is identified at the granularity of the RA procedure in an embodiment of the present disclosure; the granularity at the RA attempt level is not needed.

In Step F6S3, in an embodiment of the present disclosure, the UE records if a report is available for an MN cell and/or an SN cell so that such indication can be conveyed to the network at a suitable instant in a suitable RRC message.

In Step F6S4, in an embodiment of the present disclosure, the UE checks if a new or different SN cell has been detected based on the measurement/handover configuration received from the network (e.g., in an RRC reconfiguration or RRC connection reconfiguration message). If not, the UE waits for such event. If yes, the UE proceeds to Step F6S5.

In Step F6S5, in an embodiment of the present disclosure, the UE checks if SRB1 is allowed to indicate the report availability or report retrieval. If not, the UE goes to Step F6S9; otherwise, the UE goes to Step F6S6.

In Step F6S6, in an embodiment of the present disclosure, the UE sends an RRC MeasurementReport with report availability indicator if SRB1 is allowed for this purpose. In an example approach, the UE includes “UE-MeasurementsAvailable-r16” IE or an equivalent IE for R17 and beyond. In an embodiment of the present disclosure, the UE indicates the availability of the report(s) for MN cells only, SN cells only, and/or both MN cells and SN cells.

In Step F6S7, in an embodiment of the present disclosure, the UE checks if UEInformationRequest has been received from MN on SRB1. If not, the UE continues to wait for this message for a finite period. If yes, the UE goes to Step F6S8.

In Step F6S8, in an embodiment of the present disclosure, the UE provides UEInformationResponse to the MN via allowed SRB1. In an embodiment of the present disclosure, in the “UEInformationResponse” message containing the UE's RA, CEF, and/or RLF reports in FIG. 7 discussions above, the UE explicitly identifies the information to belong to an MN cell such as PCell or an SN cell such as PSCell.

In Step F6S9, the UE carries out random access in the SN cell. At the end of Step F7S9, MR-DC is established between the UE and the network.

In Step F6S10, in an embodiment of the present disclosure, the UE checks if it needs to send an RRC message such as MeasurementReport or RRCReconfigurationComplete on SRB3. If not, the UE waits to send an applicable RRC message on SRB3. If yes, the UE goes to Step F6S11.

In one embodiment of the present disclosure, in Step F6S11, the UE conveys the availability of reports for MN cells and/or SN cells by including the IE “UE-MeasurementsAvailable-r16” or an equivalent IE for R17 and beyond in a suitable RRC message such as MeasurementReport or RRCReconfigurationComplete on SRB3.

In Step F6S12, in an embodiment of the present disclosure, the SN sends a UEInformationRequest message requesting one or more reports such as RA, RLF, and CEF reports. In an embodiment of the present disclosure, the UE replies with a UEInformationReponse message with suitable reports that differentiate between an MN cell and an SN cell.

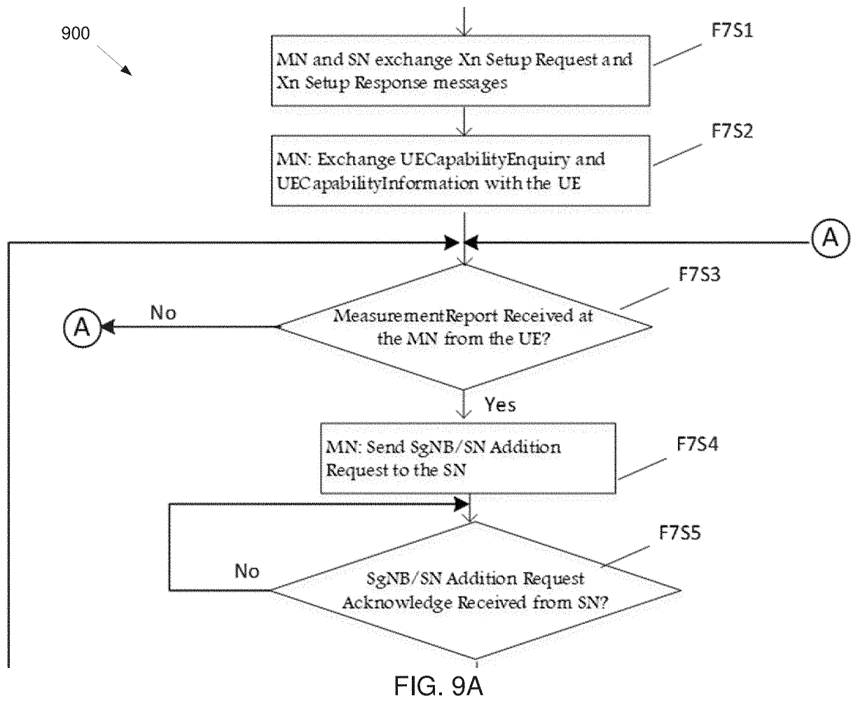

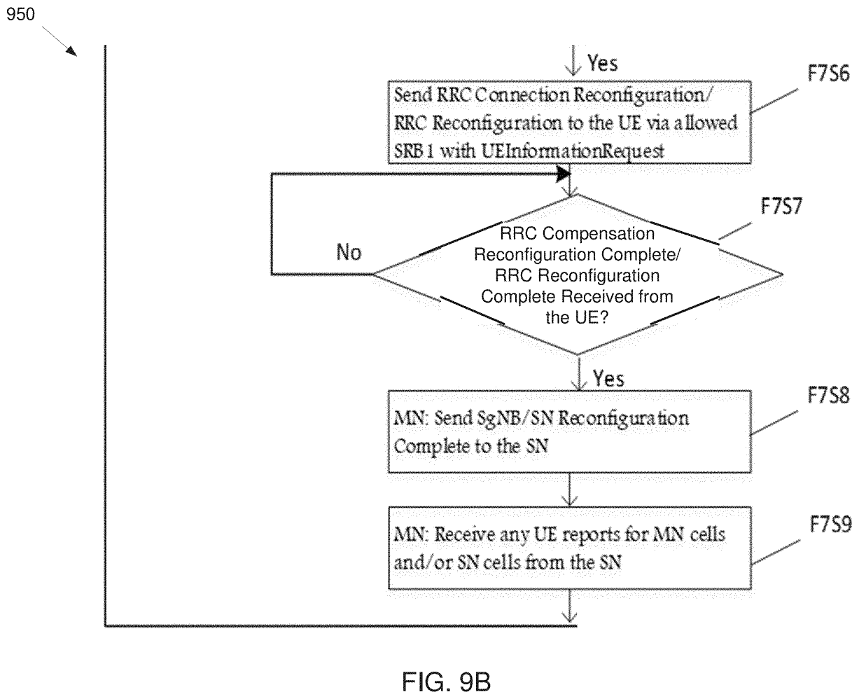

FIG. 9A illustrates an example of MN procedure 900 for enhanced RA reporting to support SON optimization in MR-DC according to embodiments of the present disclosure. The MN procedure 900 as may be performed by a BS (e.g., 101-103 as illustrated in FIG. 1). An embodiment of the MN procedure 900 shown in FIG. 9A is for illustration only. One or more of the components illustrated in FIG. 9A can be implemented in specialized circuitry configured to perform the noted functions or one or more of the components can be implemented by one or more processors executing instructions to perform the noted functions.

FIG. 9B illustrates an example of MN procedure 950 for enhanced RA reporting to support SON optimization in MR-DC according to embodiments of the present disclosure. The MN procedure 950 as may be performed by a BS (e.g., 101-103 as illustrated in FIG. 1). An embodiment of the MN procedure 950 shown in FIG. 9B is for illustration only. One or more of the components illustrated in FIG. 9B can be implemented in specialized circuitry configured to perform the noted functions or one or more of the components can be implemented by one or more processors executing instructions to perform the noted functions.

FIGS. 9A and 9B show the overall network procedure executed by the MN to illustrate example embodiments of the present disclosure to enable the UE to convey enhanced RA, CEF, and RLF reports to the eNB/gNB in support of MR-DC scenarios.

In Step F7S1, in an embodiment of the present disclosure, the MN and the SN exchange the preferences or support for obtaining an indicator from the UE about the availability of report(s) of the MN cells and SN cells using XnAP messages such as Xn setup request and Xn setup response. In an example approach, an NG-RAN node, as an MN, may indicate support for a UE indicating the availability of RA, RLF, and CEF reports for an SN cell (e.g., PSCell) using SRB1 between the MN cell and the UE. Furthermore, in an example approach, an NG-RAN node, as an MN, may indicate support for the retrieval of a UE report about SN cell(s) using SRB1 between the MN cell and the UE and forwarding of such retrieved report(s) to an SN when MR-DC is newly established or has been in existence for some time with a UE.

In one embodiment of the present disclosure, the MN's support of (i) one or more modes of the UE's indications about the report availability for MN cell(s) and SN cell(s) and (ii) one or more modes of report retrievals is predefined in specifications (an “implicit” approach) to avoid the need for an explicit signaling exchange about such support in XnAP messages.

In Step F7S2, in an embodiment of the present disclosure, the MN sends a UECapabilityEnquiry message indicating the supported MN cell and SN cell reporting modes. In an embodiment of the present disclosure, the UE sends a UECapabilityInformation message indicating the supported MN cell and SN cell reporting modes.

In one embodiment of the present disclosure, the UE's support of (i) one or more modes of the UE's indications about the report availability for MN cell(s) and SN cell(s) and (ii) one or more modes of report retrievals by the MN and/or the SN is predefined in specifications (an “implicit” approach) to avoid the need for an explicit signaling exchange about such support in RRC messages.

In Step F7S3, in an embodiment of the present disclosure, the MN checks if MeasurementReport has been received at the MN from the UE. If not, the MN waits for such message. If yes, the MN goes to Step F7S4.

In Step F7S4, in an embodiment of the present disclosure, the MN send SgNB/SN addition request to the SN with this message containing the availability of reports for MN cells and/or SN cells.

In Step F7S5, the MN checks if SgNB/SN addition request acknowledge has been received at the MN from the SN. If not, the MN waits for such message. If yes, the MN goes to Step F7S6.

In Step F7S6, the MN sends RRC connection reconfiguration/RRC reconfiguration to the UE via allowed SRB1 with UEInformationRequest. This UEInformationRequest may be coming from the SN in one approach. In another approach, the MN constructs or modifies such message to reflect the report retrieval preferences of the MN and the SN.

In Step F7S7, in an embodiment of the present disclosure, the MN checks if RRC connection reconfiguration complete/RRC reconfiguration complete has been received from the UE. If not, the MN waits for such message. If yes, the MN goes to Step F7S8.

In Step F7S8, the MN sends SgNB/SN reconfiguration complete to the SN.

In Step F7S9, the MN receives any UE reports for MN cells and/or SN cells from the SN in an embodiment of the present disclosure.

In an embodiment of the present disclosure, the XnAP “RRC transfer” message is used by the MN and/or the SN to convey the availability of the reports about SN cells and/or MN cells. In another embodiment, the XnAP “RRC transfer” message is used by the MN and/or the SN to convey the report requests (e.g., UEInformationRequest) as well as the UE reports retrieved from the UE (e.g., UEInformationResponse).

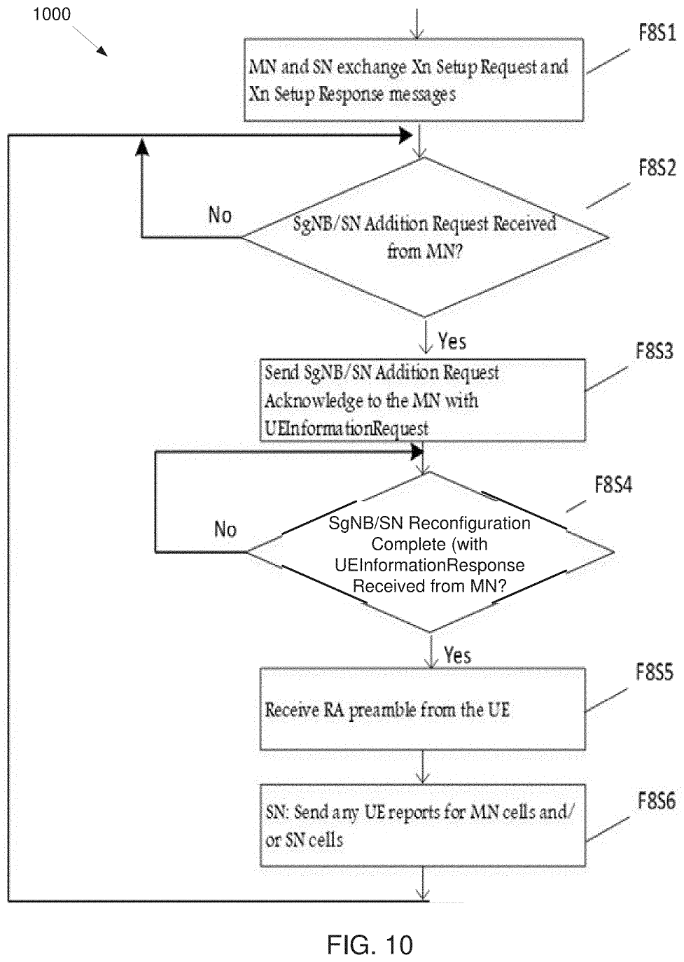

FIG. 10 illustrates an example of SN procedure 1000 for enhanced RA reporting to support SON optimization in MR-DC according to embodiments of the present disclosure. The SN procedure 1000 as may be performed by a UE (e.g., 111-116 as illustrated in FIG. 1). An embodiment of the SN procedure 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

FIG. 10 shows the overall network procedure executed by the SN to illustrate example embodiments of the present disclosure to enable the UE to convey enhanced RA, CEF, and RLF reports to the eNB/gNB in support of MR-DC scenarios.

In Step F8S1, in an embodiment of the present disclosure, the MN and the SN exchange the preferences or support for obtaining an indicator from the UE about the availability of report(s) of the MN cells and SN cells using XnAP messages such as Xn setup request and Xn setup response. In an example approach, an NG-RAN node, as an MN, may indicate support for a UE indicating the availability of RA, RLF, and CEF reports for an SN cell (e.g., PSCell) using SRB1 between the MN cell and the UE. Furthermore, in an example approach, an NG-RAN node, as an MN, may indicate support for the retrieval of a UE report about SN cell(s) using SRB1 between the MN cell and the UE and forwarding of such retrieved report(s) to an SN when MR-DC is newly established or has been in existence for some time with a UE.

In Step F8S1, in an embodiment of the present disclosure, an NG-RAN node, as an SN, may indicate support for a UE indicating the availability of RA, RLF, and CEF reports for an SN cell (e.g., PSCell) using SRB1 between the MN cell and the UE of the MN. Furthermore, in an example approach, an NG-RAN node, as an SN, may indicate support for receiving of MN-retrieved UE report(s) about SN cell(s) from the MN via the Xn interface.

In Step F8S1, in an embodiment of the present disclosure, an NG-RAN node, as an SN, may indicate support for a UE indicating the availability of RA, RLF, and CEF reports for an SN cell (e.g., PSCell) using SRB3 between the UE and an SN cell. Furthermore, in an example approach, an NG-RAN node, as an SN, may indicate support for receiving of UE report(s) about SN cell(s) using SRB3 between the UE and an SN cell.

In Step F8S1, in an embodiment of the present disclosure, an NG-RAN node, as an SN, may indicate support for a UE indicating the availability of RA, RLF, and CEF reports for an MN cell using SRB3 between the UE and an SN cell. Furthermore, in an example approach, an NG-RAN node, as an SN, may indicate support for receiving of UE report(s) about MN cell(s) using SRB3 between the UE and an SN cell.

In an embodiment of the present disclosure, the SN's support of (i) one or more modes of the UE's indications about the report availability for MN cell(s) and SN cell(s) and (ii) one or more modes of report retrievals is predefined in specifications (an “implicit” approach) to avoid the need for an explicit signaling exchange about such support in XnAP messages.

In Step F8S2, in an embodiment of the present disclosure, the SN checks SgNB/SN addition request received from MN. If not, the SN waits for such message. If yes, the SN goes to Step F8S3.

In Step F8S3, in an embodiment of the present disclosure, the SN sends SgNB/SN addition request acknowledge to the MN with UEInformationRequest. The UEInformationRequest message includes the UE reports for the cells, MN cells and/or SN cells, for which the SN is making a request.

In Step F8S4, the SN checks if SgNB/SN reconfiguration complete with UEInformationResponse has been received from MN in an example embodiment of the present disclosure. If not, the SN waits for such message. If yes, the SN goes to Step F8S5.

In Step F8S5, the SN receives an RA preamble from the UE.

In one embodiment of the present disclosure, any time after Step F8S5, the SN and the UE exchange UEInformationRequest and UEInformationResponse messages so that the SN can retrieve target RA, CEF, and RLF reports from the UE for MN cell(s) and/or SN cell(s).

In Step F8S6, the SN sends any UE reports for MN cells and/or SN cells. The SN may have received such UE reports via UEInformationResponse received via SRB1 (through the MN) or SRB3 (directly from the UE).

As described earlier in the description of FIG. 7, “In another approach, PCell is assumed to be default and SCell/PSCell is identified explicitly where needed (i.e., when a report is associated with SCell/PSCell).” In other words, when RA occurs in an SCell/PSCell, the identities of both the PCell and the SCell/PSCell are present in the RA report. This facilitates RA optimization in MR-DC scenarios. In an example implementation, the “RA-Report-r16” IE is modified to include the identities of both the PCell and the SCell/PSCell.

TABLE 1 shows the existing “RA-Report-r16” IE

```
RA-Report-r16 ::=SEQUENCE {
cellId-r16 CHOICE {
  cellGlobalId-r16 CGI-Info-Logging-r16,
    pci-arfcn-r16 SEQUENCE {
      physCellId-r16 PhysCellId,
      carrierFreq-r16 ARFCN-ValueNR
    }
  },
  ra-InformationCommon-r16 RA-InformationCommon-r16,
  raPurpose-r16 ENUMERATED {accessRelated, beamFailureRecovery,
        reconfigurati onWith Sync,
        ulUnSynchronized,
        schedulingRequestFailure,
        noPUCCHResourceAvailable,
        requestForOtherSI,
        spare9, spare8, spare7, spare6,
        spare5, spare4, spare3, spare2,
        spare1 }
1
```

TABLE 2 shows the enhanced “RA-Report-r16” IE

```
RA-Report-r16 ::=SEQUENCE {
  PCellId cellId-r16,
  PSCellId cellID-r16,
    cellId-r16 CHOICE {
      cellGlobalId-r16 CGI-Info-Logging-r16,
      pci-arfcn-r16 SEQUENCE {
        physCellId-r16 PhysCellId,
        carrierFreq-r16 ARFCN-ValueNR
      }
  },
  ra-InformationCommon-r16 RA-InformationCommon-r16,
  raPurpose-r16 ENUMERATED {accessRelated, beamFailureRecovery,
reconfigurationWithSync, ulUnSynchronized,
schedulingRequestFailure, noPUCCHResourceAvailable, requestForOtherSI,
spare9, spare8, spare7, spare6, spare5, spare4, spare3, spare2, spare1 }
}
```

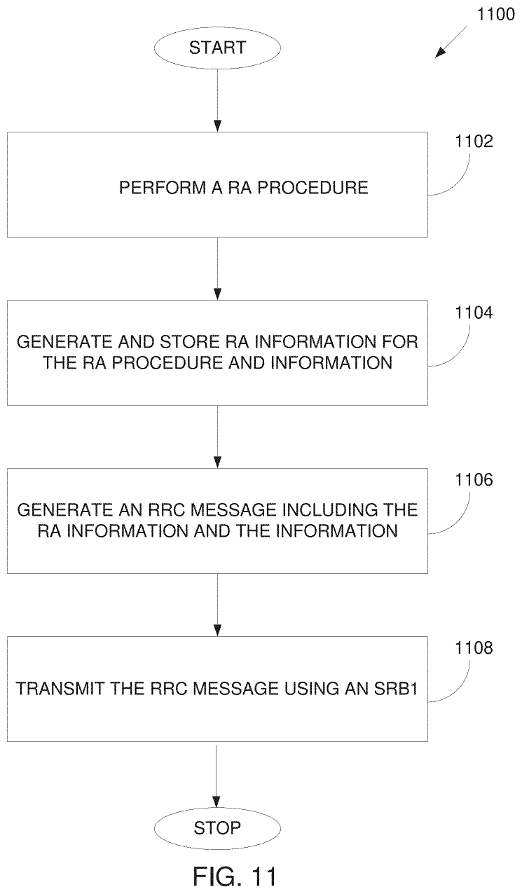

FIG. 11 illustrates a flowchart of method 1100 for an enhanced UE reporting according to embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method 1100 begins at step 1102. In step 1102, the UE performs an RA procedure in a cell of an MCG or an SCG.

Subsequently, in step 1104, the UE generates and stores RA information for the RA procedure, and information indicating whether the RA information is used for a PCell or a PSCell

Next, in step 1106, the UE generates an RRC message including the RA information and the information indicating whether the RA information is used for the PCell or the PSCell.

In step 1106, the RRC message is a UE information response message or the RRC message includes a UE information response message for an SN-BS.

In step 1106, the RA information includes at least one of RA channel configuration information, information per RA attempt including measurement information on a reference signal, a number of RA preambles transmitted, or whether a contention is detected.

Finally, in step 1108, the UE transmits, to an MN-BS, the RRC message using an SRB1.

In one embodiment, the UE generates and stores a PCell identifier (ID) as a cell ID when performing the RA procedure in a cell of the MCG, and includes the stored PCell ID to the RRC message.

In one embodiment, the UE generates and stores a PSCell ID as a cell ID when performing the RA procedure in a cell of the SCG, and includes the stored PCell ID to the RRC message.

In one embodiment, the UE generates and stores an RLF report for the PSCell, and transmits the RLF report to the MN-BS using the SRB1.

In one embodiment, the UE generates and stores a CEF report for the PSCell, and transmits the CEF report to the MN-BS using the SRB1.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to perform a random access (RA) procedure in a cell of a master cell group (MCG) or a secondary cell group (SCG); and
a processor operably coupled to the transceiver, the processor configured to:
generate, and store RA information for the RA procedure and information indicating whether the RA information is used for a primary cell (PCell) or a primary secondary cell (PSCell), and
generate a radio resource control (RRC) message including the RA information and the information indicating whether the RA information is used for the PCell or the PSCell,
wherein the transceiver is further configured to transmit, to a master node base station (MN-BS), the RRC message using a signaling radio bearer 1 (SRB1).

2. The UE of claim 1, wherein the processor is further configured to:
generate and store a PCell identifier (ID) as a cell ID when performing the RA procedure in a cell of the MCG; and
include the stored PCell ID in the RRC message.

3. The UE of claim 1, wherein the processor is further configured to:
generate and store a PSCell ID as a cell ID when performing the RA procedure in a cell of the SCG; and
include the stored PCell ID in the RRC message.

4. The UE of claim 1, wherein:
the RRC message is a UE information response message; or
the RRC message includes a UE information response message for a secondary node base station (SN-BS).

5. The UE of claim 1, wherein:
the processor is further configured to generate and store a radio link failure (RLF) report for the PSCell; and
the transceiver is further configured to transmit the RLF report to the MN-BS using the SRB1.

6. The UE of claim 1, wherein:
the processor is further configured to generate and store a connection establishment failure (CEF) report for the PSCell; and
the transceiver is further configured to transmit, the MN-BS, the CEF report using the SRB1.

7. The UE of claim 1, wherein the RA information includes at least one of RA channel configuration information, information per RA attempt including measurement information on a reference signal, a number of RA preambles transmitted, or whether a contention is detected.

8. A master node base station (MN-BS) in a wireless communication system, the MN-BS comprising:
a transceiver configured to receive, from a user equipment (UE), a radio resource control (RRC) message using a signaling radio bearer 1 (SRB1); and
a processor operably coupled to the transceiver, the processor configured to:
identify, from the RRC message, random access (RA) information for a RA procedure and information indicating whether the RA information is used for a primary cell (PCell) or a primary secondary cell (PSCell), and
determine, based on the information, whether the RA information is used for the PCell or the PSCell,
wherein the transceiver is further configured to forward the RRC message to a secondary node base station (SN-BS) when the RA information is used for the PSCell.

9. The MN-BS of claim 8, wherein:
the processor is further configured to identify a PCell identifier (ID) included in the RRC message; and
the PCell ID is identified as a cell ID when performing the RA procedure in a cell of the MCG.

10. The MN-BS of claim 8, wherein:
the processor is further configured to identify a PCell ID included in the RRC message; and
the PSCell ID is identified as a cell ID when performing the RA procedure in a cell of the SCG.

11. The MN-BS of claim 8, wherein:
the RRC message is a UE information response message; or
the RRC message includes a UE information response message for the SN-BS.

12. The MN-BS of claim 8, wherein:
the transceiver is further configured to receive, from the UE, a radio link failure (RLF) report using the SRB1;
the processor is further configured to identify the RLF report for the PSCell; and
the transceiver is further configured to transmit the RLF report to the SN-BS.

13. The MN-BS of claim 8, wherein:
the transceiver is further configured to receive, from the UE, a connection establishment failure (CEF) report using the SRB1;
the processor is further configured to identify the CEF report for the PSCell; and
the transceiver is further configured to transmit the CEF report to the SN-BS.

14. The MN-BS of claim 8, wherein the RA information includes at least one of RA channel configuration information, information per RA attempt including measurement information on a reference signal, a number of RA preambles transmitted, or whether a contention is detected.

15. A method of a user equipment (UE) in a wireless communication system, the method comprising:
performing a random access (RA) procedure in a cell of a master cell group (MCG) or a secondary cell group (SCG);
generating and storing RA information for the RA procedure and information indicating whether the RA information is used for a primary cell (PCell) or a primary secondary cell (PSCell);
generating a radio resource control (RRC) message including the RA information and the information indicating whether the RA information is used for the PCell or the PSCell; and
transmitting, to a master node base station (MN-BS), the RRC message using a signaling radio bearer 1 (SRB1).

16. The method of claim 15, further comprising:
generating and storing a PCell identifier (ID) as a cell ID when performing the RA procedure in a cell of the MCG; and
including the stored PCell ID in the RRC message.

17. The method of claim 15, further comprising:
generating and storing a PSCell ID as a cell ID when performing the RA procedure in a cell of the SCG; and
including the stored PCell ID in the RRC message.

18. The method of claim 15, wherein:
the RRC message is a UE information response message; or
the RRC message includes a UE information response message for a secondary node base station (SN-BS); and
the RA information includes at least of of RA channel configuration information, information per RA attempt including measurement information on a reference signal, a number of RA preambles transmitted, or whether a contention is detected.

19. The method of claim 15, further comprising:
generating and storing a radio link failure (RLF) report for the PSCell; and
transmitting the RLF report to the MN-BS using the SRB1.

20. The method of claim 15, further comprising:
generating and storing a connection establishment failure (CEF) report for the PSCell; and
transmitting the CEF report to the MN-BS using the SRB1.
